(19) United States
(12) Patent Application Publication
(10) Pub. No.: US 2007/0121186 A1
(43) Pub. Date: May 31, 2007

(54) Hologram read system

(75) Inventors: Mitsuru Kitamura, Tokyo (JP); Satoshi Nakasone, Tokyo (JP); Akiko Kitamura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: DAI NIPPON PRINTING CO., LTD.

(21) Appl. No.: 11/604,262

(22) Filed: Nov. 27, 2006

(30) Foreign Application Priority Data
Nov. 25, 2005 (JP) 2005-340247

(51) Int. Cl. G03H 1/22

(52) U.S. Cl. 359/33; 359/2

(57) ABSTRACT

The invention relates to a hologram read system capable of viewing a minute object that is authentication information located behind a block object in a specific direction alone, that is, a hologram read system adapted to view a minute object from a hologram wherein the minute object located behind a block object is recorded such that the minute object is blocked off by the block object and invisible upon viewing in a given direction, but visible from a direction different from said given direction. The hologram read system here comprises a light block housing 22 open at both its ends. A lighting substrate 23 with a viewing window 24 provided in its center is located at a given distance from the lower end 22d. A magnifying lens 25 adapted to magnify and view a hologram image constructed from the hologram located facing an opening at the lower end 22d is attached over the upper end 22u. Arrays 40₁, 40₂ of point light sources adapted to emit visible light are located at the lower surface of the lighting substrate 23 except for the viewing window 24, so that the any point light source in them can be selectively put on.

### BACKGROUND OF THE INVENTION

The present invention relates generally to a hologram read system, and more particularly to a read system for a hologram in which authentication information hard to view in a normal viewing state is recorded.

Patent Publication 1 has come up with a hologram with improved forgery prevention effects, in which authentication information is recorded in such a way as to be hard to view in a normal viewing state. According to that hologram with the authentication information recorded, a minute object that is the authentication information is located behind a block object of an easily visible size, so that when the hologram is viewed in a given viewing direction, the authentication information is kept out of sight in the presence of the block object, but it is visible in another viewing direction. Accordingly, the presence of the authentication information is hardly noticeable, and even when the hologram is viewed on a magnified scale by magnifying and viewing means such as a loupe, the presence of the authentication information is hardly noticeable in a given direction that is a normal viewing direction. Thus, whether the authentication information is concealed or not is unlikely to be noticeable, making sure improved forgery prevention effects. Patent Publication 1 has also come up with an authentication information check system wherein a hologram and a camera adapted to magnify and view the authentication information recorded in the hologram are fixedly located, and a lighting device for directing reconstructing illumination light to the hologram is located in a relatively movable way, so that the authentication information can be checked up.

On the other hand, Japanese Patent Application No. 2005-7126 filed by Applicant discloses a fluorescent read system for an information recorded medium using a material capable of emitting visible fluorescence.

Patent Publication 1

JP(A) 2003-228270

As regards the authentication information check system shown in Patent Publication 1, however, there is nothing specific disclosed about the arrangement, moving mechanism, etc. of the lighting device.

### SUMMARY OF THE INVENTION

In view of such situations with the prior art as described above, it is an object of the invention to provide a read system for a hologram wherein a minute object for authentication information is located behind a block object so that the minute object can be viewed from a specific direction alone.

According to the invention, the above object is achievable by the provision of a hologram read system adapted to view a minute object from a hologram wherein the minute object located behind a block object is recorded such that the minute object is blocked off by the block object and invisible upon viewing in a given direction, but visible from a direction different from said given direction, characterized by comprising a light block housing open at an upper end and a lower end, wherein a lighting substrate with a viewing window provided in a center is located within said light block housing at a given distance from, and substantially parallel with, said lower end, a magnifying lens adapted to magnify and view a hologram image reconstructed from said hologram through said viewing window and located facing an opening at said lower end is attached over an opening at said upper end or a camera capable of magnifying and viewing said reconstructed hologram image is detachably attached there-over, and an array of point light sources adapted to emit visible light is located on a lower surface of said lighting substrate except for said viewing window, so that any point light source in said array of point light sources can be selectively put on.

The invention also provides a hologram read system adapted to view a minute object from a hologram wherein the minute object located behind a block object is recorded such that the minute object is blocked off by the block object and invisible upon viewing in a given direction, but visible from a direction different from said given direction, characterized by comprising a light block housing open at an upper end and a lower end, wherein a lighting substrate with a viewing window provided in a center is located within said light block housing at a given distance from, and substantially parallel with, said lower end, a magnifying lens adapted to magnify and view a hologram image reconstructed from said hologram through said viewing window and located facing an opening at said lower end is attached over an opening at said upper end or a camera capable of magnifying and viewing said reconstructed hologram image is detachably attached there-over, and a single or multiple point light sources adapted to emit visible light are located on a lower surface of said lighting substrate except for said viewing window in such a way as to be movable said lower surface.

In the first hologram read system, said array of point light sources could comprise one linear array that extends in a direction tangent to the periphery of said viewing window, two linear arrays that extend in a direction tangent to the periphery of said viewing window, one or two or more linear arrays that extend in a direction tangent to the periphery of said viewing window and one or two or more linear arrays that extend in a diametrical direction of said viewing window, a circular array located around said viewing window, or a rectangular array located around said viewing window.

In the hologram read system of the invention, said point light sources could each be made up of, for instance, a white light emitting diode.

Said light block housing could have a substantially circular or rectangular section parallel with the lower end.

Preferably at a given position of the outer surface of said light block housing, there is an alignment mark located.

In one preferable embodiment, an infrared light source adapted to visualize information that is invisible under visible light but visualized by excitation with infrared light, or an ultraviolet light source adapted to visualize information that is invisible under visible light but visualized by excitation with ultraviolet light is located below said lighting substrate except for said viewing window.

According to the hologram read system as recited above, a hologram wherein a minute object is recorded, said minute object located behind a block object and taking an authentication information role, is illuminated with light in such a way as to make the minute object visible. While ambient light is blocked off by the light block housing, a magnifying lens or camera is used to magnify and view a hologram image for authentication information upon reconstruction by illuminating light. It is thus possible to view the authentication information in a visual, stable yet easy way.

Still other objects and advantages of the invention will in part be obvious and will in part be apparent from the specification.

The invention accordingly comprises the features of construction, combinations of elements, and arrangement of parts which will be exemplified in construction hereinafter set forth, and the scope of the invention will be indicated in the claims.

### BRIEF DESCRIPTION OF THE DRAWINGS

FIG. 1 is illustrative of how one exemplary hologram with authentication information recorded in it works so as to give an account of the principles of the hologram read system according to the invention.

FIG. 2 is an exterior view of the hologram read system.

FIG. 3 is illustrative in vertical section of the hologram read system.

FIG. 4 is illustrative of only a lighting substrate taken out of the hologram read system, as viewed from its lower end side.

FIG. 5 is illustrative of how a hologram works, which hologram has a plurality of sets each comprising a block object and a minute object recorded in it.

FIG. 6 is illustrative of a point light source array located on the lighting substrate of the hologram read system adapted to read the hologram of FIG. 5.

FIG. 7 is illustrative of a point light source array located on the lighting substrate of the hologram read system adapted to read a reflection type volume hologram.

FIG. 8 is illustrative of another example of the point light source array located on the lighting substrate of the hologram read system.

FIG. 9 is illustrative of yet another example of the point light source array located on the lighting substrate of the hologram read system.

FIG. 10 is illustrative of the direction of movement of point light sources of the hologram read system adapted to read authentication information by the mechanical movement of point light sources along the lower surface of the lighting substrate.

FIG. 11 is a circuit diagram illustrative of one exemplary arrangement for successively putting on point light sources along the array.

FIG. 12 is illustrative of one exemplary mechanism for the mechanical movement of point light sources.

FIG. 13 is a sectional view of the hologram read system, and a perspective view of the lighting substrate for the purpose of illustrating a modification to the hologram read system of the invention.

### DESCRIPTION OF THE PREFERRED EMBODIMENTS

The principles and examples of the hologram read system according to the invention will now be explained.

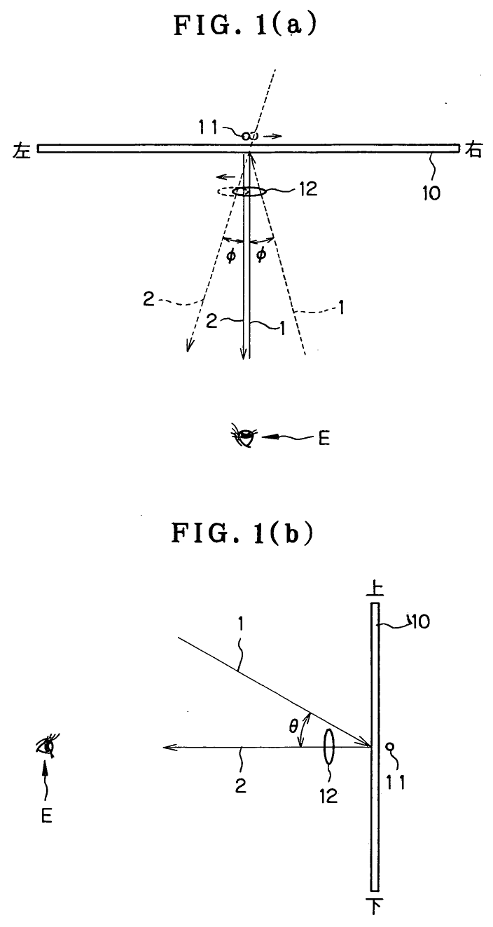

First of all, a hologram with authentication information recorded in it, such as the one proposed in Patent Publication 1, will briefly be explained, and the principles of the hologram read system of the invention will then be explained. FIG. 1 is illustrative of the action of one exemplary hologram with authentication information recorded in it, as set forth typically in Patent Publication 1. FIG. 1(a) is a view as viewed from above, and FIG. 1(b) is a view as viewed from the right side. As reconstruction illuminating light 1 is incident on a hologram 10 from the front (FIG. 1(a) ) as viewed horizontally, and from above at an angle θ with respect to a normal as viewed vertically, it permits diffracted light 2 from the hologram 10 to be diffracted about the frontal direction, so that a block object 12 of an easily visible size is reconstructed in front of the hologram 10, and a minute object 11 that is authentication information is reconstructed in the rear of the hologram 10. Because of the fact that the minute object 11 is positioned behind the block object 12, however, the minute object 11 is blocked off by the block object 12; it is not visible to the eye E of a viewer positioned in the frontal direction. As the viewer moves the eye E in either one of the right and left directions, the minute object 11 comes from behind the block object 12, and so the viewer can view it.

Instead, as the direction of incidence of the reconstructing illumination light 1 is fixed in the vertical direction and its angle φ to a normal is changed in the horizontal direction, as shown in FIG. 1(a), the direction of diffraction of the diffracted light 2, too, changes by about the angle φ in the horizontally opposite direction, so that there is a displacement in the positions where the minute object 11 and block object 12 are reconstructed. The block object 12 positioned in front of (before) the hologram 10 moves in the direction opposite to the direction of movement of the reconstructing illumination light 1, and the minute object 11 positioned in the rear of (behind) the hologram 10 moves in the same direction as the direction of movement of the reconstructing illumination light 1. As a result, there is a change in the horizontally relative positions of the block object 12 and minute object 11, so that the minute object 11 is not blocked off by the block object 12, and so becomes visible to the viewer's eye E positioned in the frontal direction of the hologram 10.

The hologram 10 is prepared in the form of a reflection type relief hologram with a reflective layer provided on its relief or back surface, or a reflection type volume hologram. However, the reflection type relief hologram is constructed in the form of a rainbow hologram that can be reconstructed with white light or incoherent light. When the hologram 10 is constructed as the reflection type volume hologram, information about the relative positions of the block object 12 and minute object 11 is recorded in it in not only the horizontal direction but also the vertical direction, so that even when the reconstructing illumination light 1 is vertically moved, the minute object 11 is again not blocked off by the block object 12, and so becomes visible to the viewer's eye E positioned in the frontal direction. When the hologram 10 is constructed as the rainbow hologram, however, three-dimensional information is recorded in it in the horizontal direction alone; when the reconstructing illumination light 1 goes up or down, the minute object 11 remains out of sight.

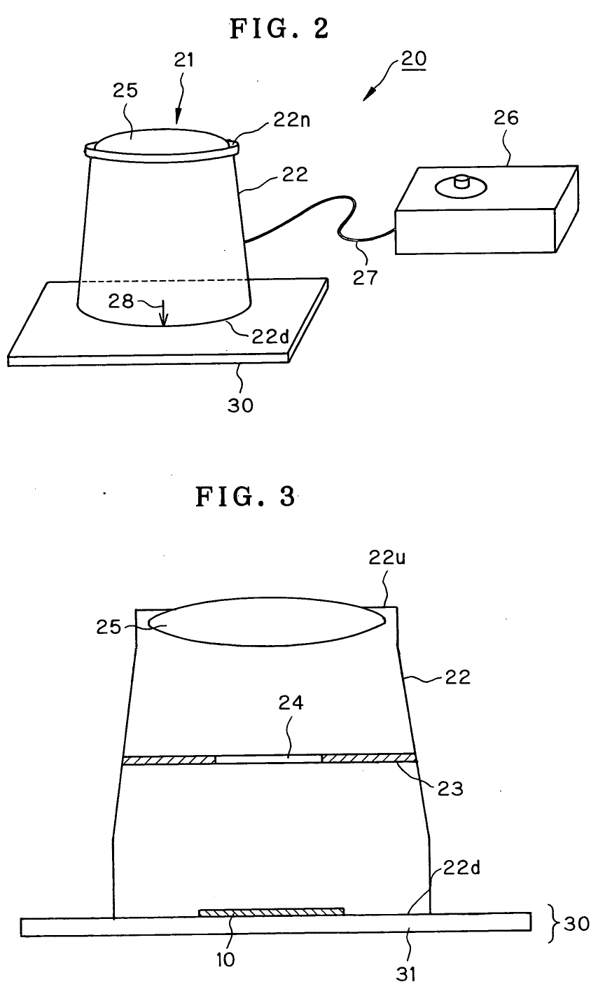

Now, some embodiments of the hologram read system according to the invention used to embody such principles are explained. FIG. 2 is a schematic exterior view of the hologram read system, and FIG. 3 is illustrative in vertical section of the hologram read system. In a hologram read system 20 of the invention, a main component 21 of the hologram read system is connected with a control device 26 by way of a connecting cord 27, as shown in the exterior view of FIG. 2. The main component 21 comprises a cylindrical form of light block housing 22 open at its upper end 22u and lower end 22d. Within the housing 22, a substrate 23 for lighting purposes (hereinafter called the lighting substrate) with a center viewing window 24 is mounted at a given distance from, and parallel with, the lower end 22d, and a magnifying lens 25 capable of magnifying and viewing a reconstructed hologram image is mounted over an opening at the upper end 22u. The outside of the light block housing 22 could be in a cylindrical, truncated conical, polyhedral cylindrical or other like configuration. At a given position on the outer surface of the light block housing 22, there is an alignment mark 28 provided, which facilitates alignment of the direction of the hologram read system with the hologram 10. And then, to enable a hologram image reconstructed from the hologram 10 to be magnified and viewed with such a hologram read system 20, an information recorded medium having the hologram 10, wherein such authentication information as described above is recorded on the surface of, for instance, a substrate 31, is brought in contact with the opening at the lower end 22d of the light block housing 22 while the hologram 10 is positioned within the opening at the lower end 22d.

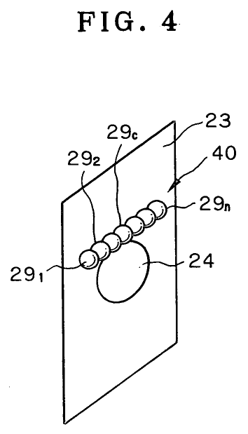

The illumination light source located on the lighting substrate 23 is now explained. FIG. 4 is illustrative of only the lighting substrate 23 removed out of the housing 22, as viewed from the lower end 22d side. The outside shape of the lighting substrate 23 is in conformity with the inside shape of the light block housing 22. In the embodiment here, however, it is illustrated in a rectangular form for brevity. In the middle of the lighting substrate 23, there is the viewing window 24 provided, and a linear point light source array 40 comprising a plurality of point light sources 29₁, 29₂, . . . , 29ₙ such as white LEDs is located near the upper edge of that viewing window 24. The lighting substrate 23 is fitted in the light block housing 22 such that when the information-recorded medium 30 is viewed with the alignment mark 28 in alignment with the upper direction of the hologram 10, the point light source array 40 is oriented in alignment with the left-and-right transverse direction. The distance of the point light source array 40 from the center of the viewing window 24 is determined such that when the center point light source 29_{c}, in the point light source array 40 is put on, the minute object 11 and block object 12 are reconstructed at positions indicated by solid lines in FIG. 1; that is, light from the point light source 29c becomes the reconstructing illumination light 1 that falls from above at the angle θ to the normal to the hologram 10.

As the point light source array 40 comprising such point light sources 29₁, 29₂, . . . , 29ₙ is located in the transverse direction and the point light sources 29₁, 29₂, . . . , 29ₙ in the array are successively put on from right to left or left to right or the point light source near the left or right end of the point light source array 40 is selectively put on, it permits the minute object 11 that is the authentication information hidden off by the block object 12 to be magnified through the magnifying lens 25 and read from the front.

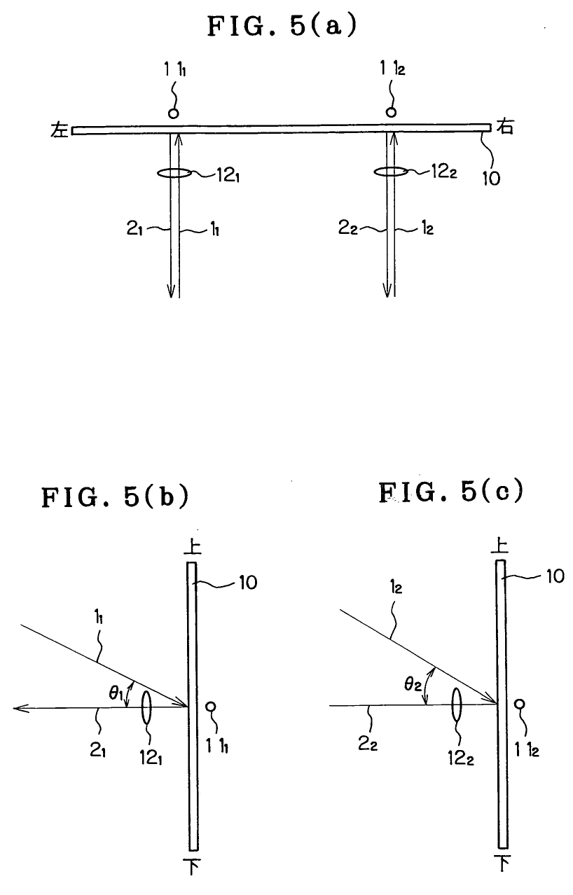

In some cases, a plurality of sets of block object 12 and minute object 11 to be reconstructed with a plurality of reconstructing illumination light beams having different angles of incidence are recorded in the hologram 10, as shown in FIG. 5. FIG. 5(a) is a view of the hologram 10 as viewed from above; FIG. 5(b) is a view of a hologram portion reconstructed with one reconstructing illumination light 1₁ as viewed from the right side; and FIG. 5(c) is a view of a hologram portion reconstructed with another reconstructing illumination light 1₂ as viewed from the right side. As the one reconstructing illumination light 1₁ is incident from above on the hologram 10 at an angle θ₁ with respect to the normal, it permits diffracted light 2₁ from the hologram 10 to be diffracted about the frontal direction, so that a block object 12₁, is reconstructed in front of the hologram 10, and a minute object 11₁ is reconstructed in the rear of the hologram 10 while the minute object 11₁, is positioned behind the block object 12₁. As the another reconstructing illumination light 1₂ is incident from above on the hologram 10 at an angle θ₂ to the normal, said angle θ₂ different from the above angle θ₁, it permits diffracted light 2₂ from the hologram to be diffracted about the frontal direction, so that another block object 12₂ is reconstructed in front of the hologram 10 and another minute object 11₂ is reconstructed in the rear of the hologram 10 while the minute object 11₂ is positioned behind the block object 12₂.

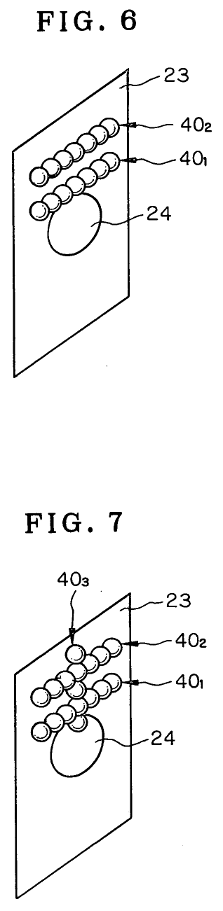

In order to enables the minute objects 11₁, 11₂ that are the authentication information for such a hologram 10 to be viewed from the front, two rows of parallel point light source arrays 40₁, 40₂ are located near the upper edge of the viewing window 24 in the lighting substrate 23, as shown in FIG. 6. The point light source arrays 40₁, 40₂ are oriented in the same left-and-right transverse direction as is the case with the point light source array 40 of FIG. 4. The distance of one point light source array 40₁, from the center of the viewing window 24 is determined such that when the point light source at the center of that array is put on, the minute object 11₁ and block object 12₁, in the layout of FIG. 5(b) are reconstructed, and the distance of another point light source array 40₂ from the center of the viewing window 24 is determined such that when the point light source at the center of that array is put on, the minute object 11₂ and block object 12₂ in the layout of FIG. 5(c) are reconstructed.

As either one of such point light source arrays 40₁, 40₂ is successively put on from right to left or left to right or the point light source near the left or right end of either one of the point light source arrays 40₁, 40₂ is selectively put on, it permits the minute object 11₁, or 11₂ that is the authentication information hidden off by the block object 12₁, or 12₂ to be magnified through the magnifying lens 25 and read from the front. Alternatively, as the point light sources in both the point light source arrays 40₁, 40₂ are successively put on from right to left or left to right or the point light sources near the left or right ends of both the point light source arrays 40₁, 40₂ are selectively put on, it permits the minute objects 11₁ and 11₂ that are the authentication information hidden off by the block objects 12₁, and 12₂ to be simultaneously magnified through the magnifying lens 25 and read from the front. It is noted that when the point light sources in the point light source array 40₁, and the point light sources in the point light source array 40₂ are put on at the same time, reconstructed images are often viewed as they overlap each other. In this case where the authentication information is hardly to view, it is preferable to selectively switch only one point light source array on.

When the hologram 10 is the rainbow hologram as described above, there is the three-dimensional information recorded in it in the horizontal direction alone. In order to make it possible for the viewer to view the minute object 11, 11₁, 11₂ that is the authentication information from the front, it is only needed to extend the point light source array 40, 40₁, 40₂ on the lighting substrate 23 in the horizontal direction of the hologram with the three-dimensional information recorded in it, as shown in FIGS. 4 and 6. However, when the hologram 10 is constructed as the reflection type volume hologram, it is possible to view the minute object 11, 11₁, 11₂ from the front even upon vertical movement of the reconstructing illumination light 1, because the three-dimensional information is recorded in it in not only the horizontal direction but also the vertical direction. To this end, for instance, yet another point light source array 40₃ is located on the lighting substrate 23, which extends in a direction orthogonal to the point light source arrays 40₁, 40₂. As the point light source array 40₃ is put on successively from the viewing window 24 side to the outside or the point light source array near the outer end of the point light source 40₃ is selectively put on, it permits the minute objects 11, 11₁, 11₂ that is the authentication information hidden off by the block objects 12, 12₁, 12₂ to be magnified through the magnifying lens 25 and viewed from the front. It is noted that point light source arrays 40₁, 40₂ in FIG. 7 are provided to read two minute objects 11₁, 11₂ selectively or simultaneously as is the case with the FIG. 6.

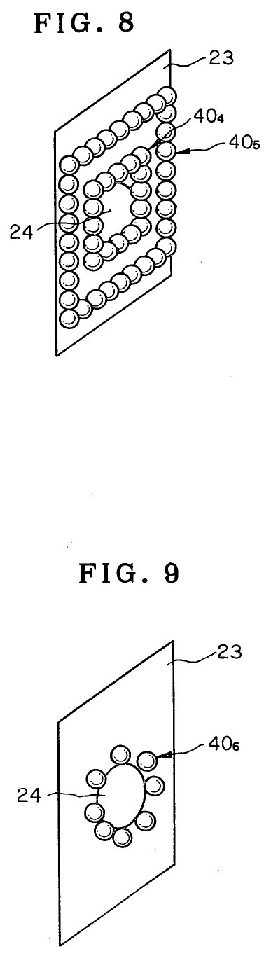

As described previously, at the given position of the outer surface of the light block housing 22, there is the alignment mark 24 provided so as to facilitate alignment of the reader system with the hologram 10. Instead for or in addition to such an alignment mark, one or multiple rows of point light source arrays 40₄, 40₅ may be located on the lighting substrate 23 around and coaxial with the viewing window 24, as shown in FIG. 8. In this case, there is an improvement in the degree of flexibility in the orientation of the light block housing 22 set with respect to the hologram 10. And then, the outside shape of the light block housing 22 is preferably configured into a square in section in conformity with the orientation of the sides of the square point light source arrays 40₄, 40₅, because alignment of the hologram 10 with the light block housing 22 is easily achievable.

It is also preferable that a circular array 40₆ of point light sources is located around and coaxial with the viewing window 24 as shown in FIG. 9, because there is no need of aligning the light block housing 22 with the hologram 10. In this case, how the authentication information comes into sight is somewhat different from that in the case where an illuminating light source array is in a linearly arrangement; however, there is practically no problem.

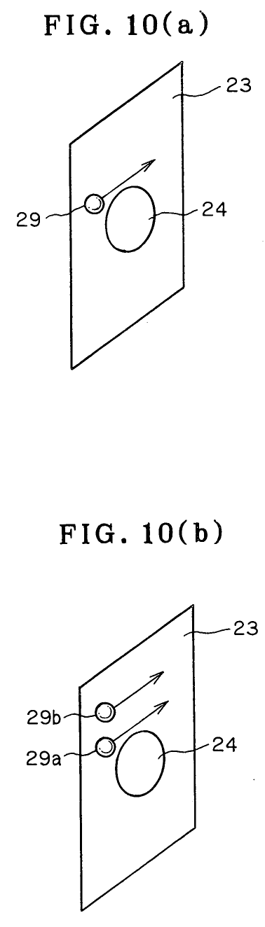

In the foregoing embodiments, the point light source arrays 40 and 40₁-40₆ comprising a plurality of point light sources 29₁, 29₂, . . . , 29ₙ such as white LEDs are used as the light sources for lighting the hologram 10 located below the lower surface of the lighting substrate 23, and the point light sources 29₁, 29₂, . . . , 29ₙ are successively put on along the array for optional selection and change of the lighting position. However, it is also possible to locate one LED or other point light source or a plurality of LED or other point sources corresponding to the number of point light source arrays at the lower surface of the lighting substrate 23 in such a way that their movement is controllable. In this case, if one or plural such point light sources are mechanically moved along the lower surface of the lighting substrate 23, it is then possible to move the illuminating point light sources to a desired position to the hologram 10, thereby allowing the minute objects 11₁, 11₂ that are the authentication information for the hologram to be viewed from the front. FIG. 10 is illustrative of one exemplary direction of movement to that end. More specifically, an example of FIG. 10(a) corresponds to FIG. 4, wherein one LED or other point light source 29 is located at the lower surface of the lighting substrate 23 in such a way as to be movable as indicated by an arrow, and by moving that point light source 29 along a locus corresponding to the point light source array 40 of FIG. 4, it is possible to view the minute object 11. An example of FIG. 10(b) corresponds to FIG. 6, wherein two LED or other point light sources 29a, 29b are located at the lower surface of the lighting substrate 23 in such a way as to be movable as indicated by arrows, and by moving them along loci corresponding to the point light source arrays 40₁, 40₂ in FIG. 6, respectively, it is possible to view the minute objects 11₁, 11₂. It is understood that if there is one point light source 29 provided as in FIG. 10(a) and that one point light source 29 is moved along the loci corresponding to the point light source arrays 40₁, 40₂ in FIG. 6, it is then possible to selectively read two minute objects 11₁, 11₂. The same as in FIGS. 10(a) and 10(b) could apply to the movement of one or two or more point light sources 29, 29a, 29b along the loci corresponding to the point light source arrays 40₁-40₆ in FIGS. 7 to 9, too.

It is understood that the positions to which one or two or more point light sources 29, 29a, 29b are moved are not only on but also near the loci corresponding to the point light source arrays 40 and 40₁-40₆ in FIGS. 4 and 6-10, and that they are movable to an area between the adjacent loci.

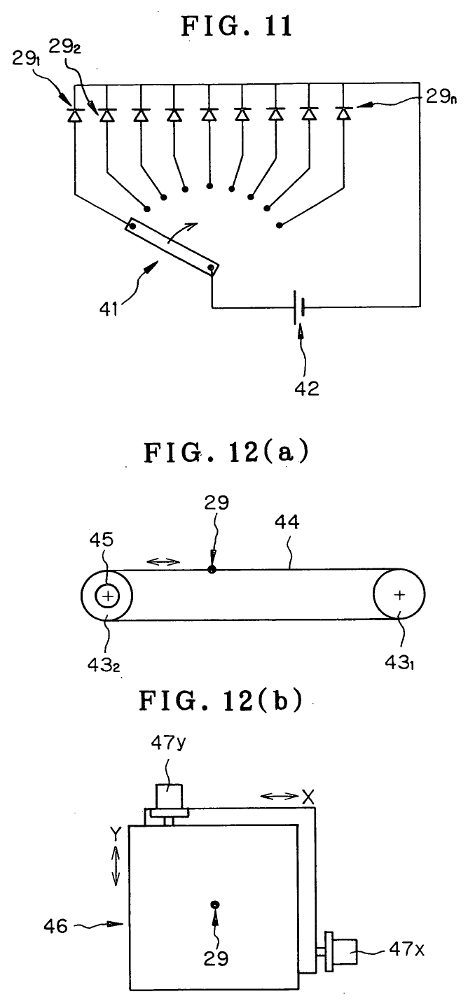

In order to put on the point light sources 29₁, 29₂, . . . , 29ₙ successively along the point light sources 40 and 40₁-40₆ in FIGS. 4 and 6-9, it is preferable that such a rotary switch 41 as shown in FIG. 11 is located in the control device 26 and that rotary switch 41 is used to put on the point light sources 29₁, 29₂, . . . , 29ₙ successively in this order. And of course, an electronic changeover switch could be used to the same purpose, too.

For the mechanism by which the point light sources 29, 29a, 29b in FIG. 10 are moved, various mechanical moving mechanisms could be used. For instance, in order to move one point light source 29 on a simple linear locus, it is preferable that the point light source 29 is attached integrally to one point on a belt 44 extending between pulleys 43₁, and 43₂, and the movement of the belt 44 is controlled by control of rotation of a motor 45 adapted to rotate one pulley 43₂, as shown in FIG. 12(a) In order to provide free movement of one point light source 29 along a two-dimensional plane on any desired locus, it is preferable that the point light source 29 is attached to one point on an X-Y table 46 that is controllable to any desired position by means of a motor 47x adapted to move it in the X direction and a motor 47y adapted to move it in the Y direction, as shown in FIG. 12(b).

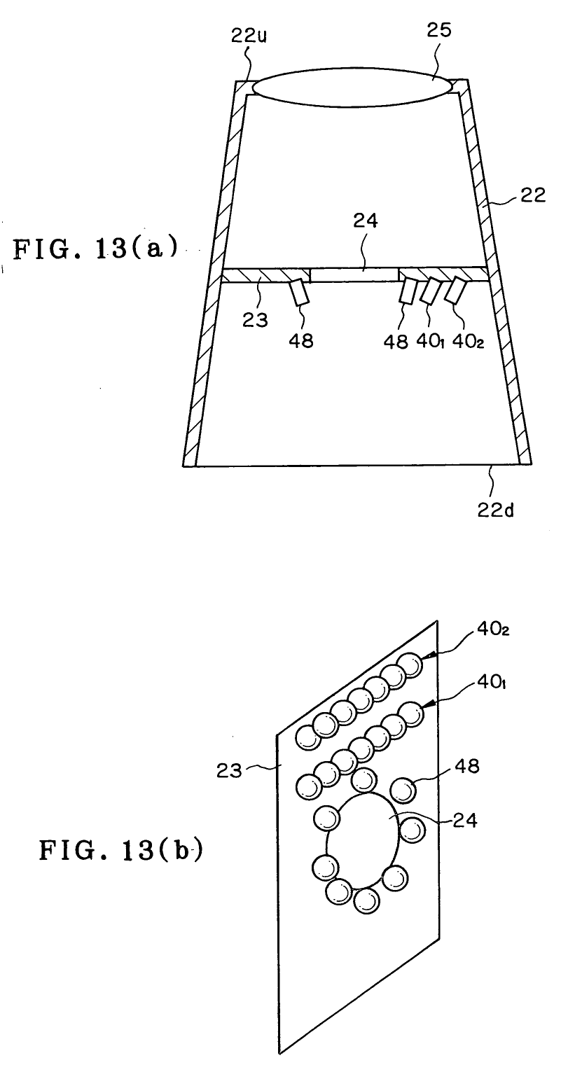

To add to this, an infrared light source capable of visualizing and viewing information that remains invisible under visible light but is visualized by excitation with infrared light may be located at any desired position below the lighting substrate 23 except for the viewing window 24, as is the case with the fluorescent reader system set forth in Japanese Patent Application No. 2005-7126. One example is now explained with reference to FIG. 13(a) that is a sectional view of the reader system and FIG. 13(b) that is a perspective view of the lighting substrate. In this example, a plurality of infrared light emitting LEDs 48 capable of emitting infrared excitation light are located inside point light source arrays 40₁, 40₂ comprising hologram-read white LEDs or the like located at the lower surface of the lighting substrate 23 and around the viewing window 24. When information drawn by a fluorescent material that is visualized by infrared excitation light is located facing an opening in the lower end 22d of the main component 21 of the reader system for reading purposes, point light sources 40₁, 40₂ in the visible range are put off while the infrared light emission LED 48 is put on.

While the hologram read system of the invention has been described with reference to its principles and examples, it is understood that the invention is not limited thereto and many modification could be made thereto. With the hologram read system of the invention, it is possible not only to magnify and view a reconstructed image in a visual way but also to use a TV camera through which a reconstructed image is magnified and viewed. To this end, while the magnifying lens 25 remains attached to the upper end 22u of the light block housing 22 or after the magnifying lens 25 is taken out, it is preferable to locate the TV camera in place. Further, an ultraviolet light source capable of visualizing information that remains invisible under visible light but is visualized by excitation with ultraviolet light could be provided in place.

1. A hologram read system adapted to view a minute object from a hologram wherein the minute object located behind a block object is recorded such that the minute object is blocked off by the block object and invisible upon viewing in a given direction, but visible from a direction different from said given direction, characterized by comprising a light block housing open at an upper end and a lower end, wherein a lighting substrate with a viewing window provided in a center is located within said light block housing at a given distance from, and substantially parallel with, said lower end, a magnifying lens adapted to magnify and view a hologram image reconstructed from said hologram through said viewing window, said hologram being located facing an opening at said lower end, is attached over an opening at said upper end or a camera capable of magnifying and viewing said reconstructed hologram image is detachably attached there-over, and an array of point light sources adapted to emit visible light is located on a lower surface of said lighting substrate except for said viewing window, so that any point light source in said array of point light sources can be selectively put on.

2. A hologram read system adapted to view a minute object from a hologram wherein the minute object located behind a block object is recorded such that the minute object is blocked off by the block object and invisible upon viewing in a given direction, but visible from a direction different from said given direction, characterized by comprising a light block housing open at an upper end and a lower end, wherein a lighting substrate with a viewing window provided in a center is located within said light block housing at a given distance from, and substantially parallel with, said lower end, a magnifying lens adapted to magnify and view a hologram image reconstructed from said hologram through said viewing window, said hologram being located facing an opening at said lower end, is attached over an opening at said upper end or a camera capable of magnifying and viewing said reconstructed hologram image is detachably attached there-over, and a single or multiple point light sources adapted to emit visible light are located on a lower surface of said lighting substrate except for said viewing window in such a way as to be movable said lower surface.

3. The hologram read system according to claim 1, characterized in that said array of point light sources comprises one linear array that extends in a direction tangent to a periphery of said viewing window.

4. The hologram read system according to claim 1, characterized in that said array of point light sources comprises two linear arrays that extend in a direction tangent to a periphery of said viewing window.

5. The hologram read system according to claim 1, characterized in that said array of point light sources comprises one or two or more linear arrays that extend in a direction tangent to a periphery of said viewing window and one or two or more linear arrays that extend in a diametrical direction of said viewing window.

6. The hologram read system according to claim 1, characterized in that said array of point light sources comprises a circular array located around said viewing window.

7. The hologram read system according to claim 1, characterized in that said array of point light sources comprises a rectangular array located around said viewing window.

8. The hologram read system according to any one of claims 1 to 7, characterized in that said point light sources each comprises made up of a white light emitting diode.

9. The hologram read system according to any one of claims 1 to 2, characterized in that said light block housing has a substantially circular section parallel with said lower end.

10. The hologram read system according to any one of claims 1 to 2, characterized in that said light block housing has a substantially rectangular section parallel with said lower end.

11. The hologram read system according to any one of claims 1 to 2, characterized in that an alignment mark is provided at a given position of an outer surface of said light block housing.

12. The hologram read system according to any one of claims 1 to 2, characterized in that an infrared light source adapted to visualize information that is invisible under visible light but visualized by excitation with infrared light is located below said lighting substrate except for said viewing window.

13. The hologram read system according to any one of claims 1 to 2, characterized in that an ultraviolet light source adapted to visualize information that is invisible under visible light but visualized by excitation with ultraviolet light is located below said lighting substrate except for said viewing window.
